(19) United States
(12) Patent Application Publication
(10) Pub. No.: US 2013/0112817 A1
(43) Pub. Date: May 9, 2013

(54) CLAMP FOR ATTACHING PIPES OR LINES

(71) Applicant: NORMA GERMANY GMBH, Maintal (DE)

(72) Inventor: Dennis UNGER, Neuberg (DE)

(73) Assignee: NORMA GERMANY GMBH, Maintal (DE)

(21) Appl. No.: 13/660,323

(22) Filed: Oct. 25, 2012

(30) Foreign Application Priority Data
Nov. 4, 2011 (DE) 10 2011 117 696.2

(51) Int. Cl. F16L 3/10

(52) U.S. Cl. 248/74.4

(57) ABSTRACT

clamp for attaching pipes or lines. The clamp includes a first arm arranged on a base and a second arm arranged on a carriage. The carriage is slidably arranged in the base so that the first and second arms are connectable to one another.

### CROSS-REFERENCE TO RELATED APPLICATIONS

The present application claims priority under 35 U.S.C. §119 of German Patent Application No. 10 2011 117 696.2 filed Nov. 4, 2011, the disclosure of which is expressly incorporated by reference herein in its entirety.

### BACKGROUND OF THE INVENTION

1. Field of the Invention

The invention relates to a clamp for attaching pipes or lines, which has a first arm and a second arm, which can be connected to one another.

2. Discussion of Background Information

Clamps of this type are used, for example, in order to attach pipes or line systems. The clamp is thereby firstly attached to a bearing structure, for example, a wall or a frame, and subsequently the pipe or the line is inserted into the clamp. The clamp is then closed by connecting the arms, so that the arms surround the pipe or the line.

In order to be able to insert the pipe or the line into the clamp, a relatively wide opening of the clamp is necessary. The arms of the clamp generally have a relatively high elasticity for this purpose, so that their free ends, with which they can be connected, can be bent relatively far away from one another. However, this has the disadvantage that the clamp overall has a relatively high elasticity and in particular does not permit a rigid connection of the pipe or the line.

### SUMMARY OF THE INVENTION

Embodiments of the invention provide a clamp with high stiffness.

Accordingly, in a clamp of the type mentioned above, the first arm is arranged on a base and the second arm is arranged on a carriage. The carriage is slidably arranged on the base.

The entire clamp, i.e., the arms, the base and the carriage, can then be embodied or formed in a relatively rigid manner. A deformation of the arms to fix pipes or lines is then not necessary. For example, the arms can be bent towards one another and in a state connected to one another surround a circular cross section. By displacing the carriage with the second arm with respect to the base and the first arm, the clamp can be opened wide enough in order to accommodate a pipe or line element. Subsequently, the arms are moved towards one another by displacement of the carriage and the clamp is closed. In this way, a rigid retention of the line or of the pipe is possible. In all, a clamp with high stiffness is thus obtained.

Preferably, the arms on their free ends respectively have a connection geometry with which in particular a locking connection can be produced. Thus, a positive connection of the arms to one another is possible via the connection geometries. For example, the connection geometry on the first arm can be embodied or formed as a hook and the connection geometry on the second arm can be embodied or formed as a recess. The hook then locks into the recess as soon as the clamp is closed. A very stable positive connection absorbing high forces is thus produced. The recess can be surrounded by an essentially U-shaped edging, via which a guidance of the hook can take place. Axial forces can also be absorbed by the connection geometry thereby. At the same time, the hook is protected from external forces by the edging, so that an accidental opening or damage to the hook by external force effects is unlikely.

Advantageously, the base has an attachment section, which is arranged on an end of the base facing away from the first arm. The attachment section is used to fix the clamp to a bearing structure, such as, for example, a wall, a roof or a floor of a housing or the body of a vehicle or aircraft. The attachment section can have, for example, an opening for accommodating an attachment device, such as, e.g. a screw. It is thus relatively easily possible to attach the clamp.

Preferably, the carriage is guided on a guide, which penetrates a recess of the carriage. The carriage is therefore guided positively. The guide can thereby be embodied or formed as an extension of the base that extends parallel to the base. The guide is embodied or formed for example as a dovetail guide and due to its shaping in interaction with the recess causes a rotation prevention. Overall the carriage can thereby be guided on the guide in a relatively stable manner.

It is particularly advantageous that an underside of the carriage terminates flush with an underside of the base. The underside of the base and of the carriage can then be arranged on a smooth surface. The attachment of the clamp is thus relatively simple.

Preferably, a guide region of the carriage can be accommodated in part in a recess in the base below the first arm. When sliding the carriage to the base, that is, when closing the clamp, an additional positive connection between the carriage and the base thus occurs. A very high stiffness of the clamp results thereby and simultaneously relatively high forces can be transferred.

Preferably, an insert is arranged on an inside of the arms, which insert has a first material. The base, the carriage and the arms have a second material. The two materials may undergo in particular a chemical adhesive connection to one another. When the clamp is mounted, the insert lies between the arms and the pipe or the line. The insert can thereby have a certain elasticity for example, and thus cause a vibration uncoupling, while the second material of the base, the carriage and the arms is relatively stiff and unyielding. By way of slight elastic deformation of the first material of the insert during the closing of the clamp around a pipe or line element, a very firm retention of the pipe or line element can thereby also be achieved, since a preloading is caused by the deformation of the first material. A retention free from play thus results.

Preferably, the first material has a silicone, in particular a liquid silicone, and the second material has a thermoplastic material. The clamp, that is, the base, the carriage and the arms, can be embodied or formed with a relatively high stiffness due to the use of thermoplastic material. The use of silicone renders possible a vibration damping or an uncoupling of the environment from vibrations and thus a secure fit of the pipe or line element in the clamp. Liquid silicone can be applied or sprayed on, for example in the liquid state, so that the silicone can undergo a close connection with the thermoplastic material. This results in a very secure retention of the insert on the inside of the arms.

Preferably, the clamp can be used in a temperature range of −55° C. to +260° C. This results in very broad fields of application for example in aircraft. A temperature range of this type can be realized with the use of thermoplastic material and silicone.

It is particularly advantageous that the materials of the clamp are fuel-resistant. The clamp can then also be used in chemical plants or for example for fixing fuel lines. Thermoplastic material as well as silicone are fuel-resistant materials.

Embodiments of the invention are directed to a clamp for attaching pipes or lines. The clamp includes a first arm arranged on a base and a second arm arranged on a carriage. The carriage is slidably arranged in the base so that the first and second arms are connectable to one another.

According to embodiments, the first and second arms can have free ends with a connection geometry. The connection geometry may produce a locking connection.

In accordance with embodiments of the invention, the base can have an attachment section arranged on an end of the base facing away from the first arm.

In other embodiments, the carriage can include a guide that penetrates a recess of the carriage.

According to other embodiments, an underside of the carriage may be structured to be flush with an underside of the base.

In accordance with still other embodiments of the invention, a guidable region of the carriage can be accommodatable in part in a recess in the base.

In further embodiments, an insert including a first material can be arranged on an inside of the arms. The base, the carriage and the arms may include a second material. The first material may include a silicone, and the silicone can include a liquid silicone. Further, the second material may include a thermoplastic material. The first and second materials of the clamp can be fuel-resistant.

Further, the clamp can be structured for use in a temperature range of −55° C. to +260° C.

Embodiments of the invention are directed to a clamp structured to connect pipes or lines. The clamp includes a first arm connected to a base, and a second arm slidably guided in the base to slidably, whereby the first and second arms are slidably engageable with each other. A locking element is coupled to the first arm, a complementary locking element is coupled to the second arm, and inserts are formed on inside surfaces of the first and second arms.

According to embodiments, the inserts can include a first material and the base and the arms can include a second material.

According to other embodiments, the first and second materials can be fuel-resistant.

In accordance with still yet further embodiments of the present invention, the first material may include a silicone and the second material may include a thermoplastic material. Further, the silicone comprises a liquid silicone.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a clamp in the opened state; and

FIG. 2 illustrates a clamp in the closed state.

### DETAILED DESCRIPTION OF THE EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed in practice.

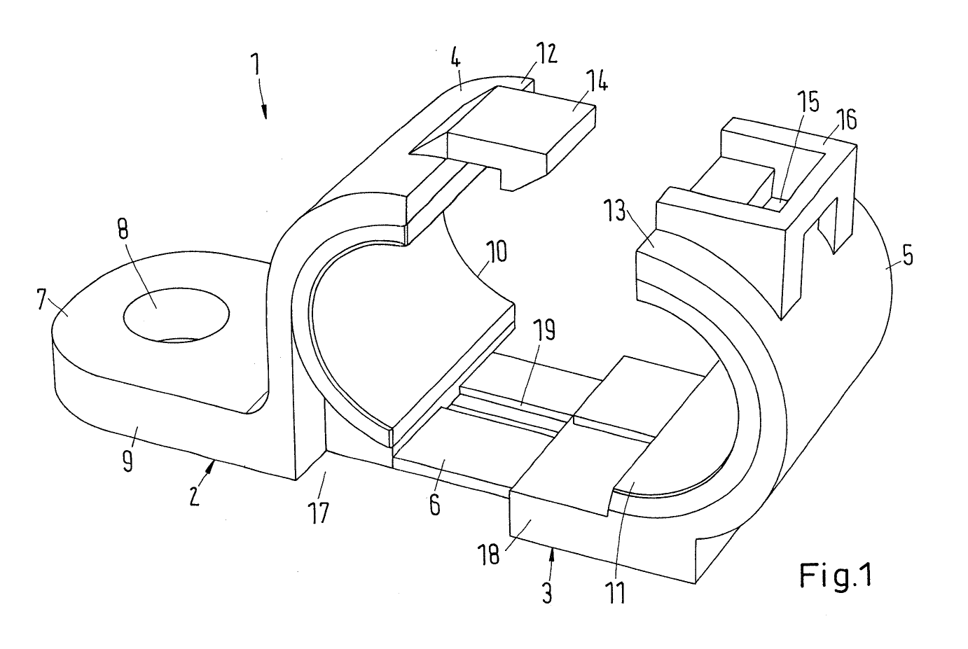

In FIG. 1 the clamp, which can be used as an attachment clamp for pipes or lines, is shown in a three-dimensional representation. The clamp 1 has a base 2, a carriage 3, a first arm 4 and a second arm 5. The carriage 3 is guided in a linear manner on a guide 6, which is embodied or formed in one piece with the base 2. The guide 6 penetrates a recess of the carriage 3. The guide 6 is embodied or formed with an essentially rectangular cross section, so that the recess has a corresponding cross section so that a rotation prevention as well as a linear guide takes place. This is additionally improved by a web 19, which is embodied or formed on a top of the guide 6.

The base 2 has an attachment section 7, which has an opening 8 to accommodate an attachment device. With an attachment device, for example, a screw or a rivet, the clamp 1 can be attached to a body or a different stationary element. The clamp 1 is placed with an underside 9 of the attachment section 7 on the corresponding element and attached with the aid of the attachment device, which is guided through the opening 8.

The first arm 4 is embodied or formed in one piece with the base 2 and the second arm 5 is embodied or formed in one piece with the carriage 3. The base 2 with the guide 6 and the first arm 4 as well as the carriage 3 with the second arm 5 are made of a second material, in this case a thermoplastic material. A two-part insert 10, 11 is arranged on an inside of the first arm 4 and of the second aim 5. This insert covers respectively completely the inside of the first arm 4 or of the second arm 5 and, like the arms 4, 5, is embodied or formed in a semi-circular manner. The insert 10, 11 is produced from a first material, which is different from the second material.

In this example, the insert 10, 11 has a silicone, which has been sprayed onto the inside of the arms 4, 5.

A connection geometry 14, 15 is embodied or formed on free ends 12, 13, respectively, of the arms 4, 5, such that the connection geometry 14 on the first arm 4 is embodied or formed as a hook and the connection geometry 15 on the second arm 5 is embodied or formed as a recess. The connection geometry 15 is surrounded by a U-shaped edging 16, which surrounds the hook-shaped connection geometry 14 after locking into the recess of the connection geometry 15. An upper edge of the edging 16 erminates with a top of the connection geometry 14, so that the connection geometry 14 is relatively well protected from external forces that could cause a release of the connection geometries 14, 15.

The hook-shaped connection geometry 14 is thereby embodied or formed in one piece with the first arm 4. The edging 16 is embodied or formed in one piece with the second arm 5.

Below the first arm 4 the base 2 has a recess 17, into which a guide region 18 of the carriage 3 is inserted during the closing of the clamp 1. This results in a relatively large-area connection between the carriage 3 and the base 2, so that a high stiffness of the clamp 1 is obtained.

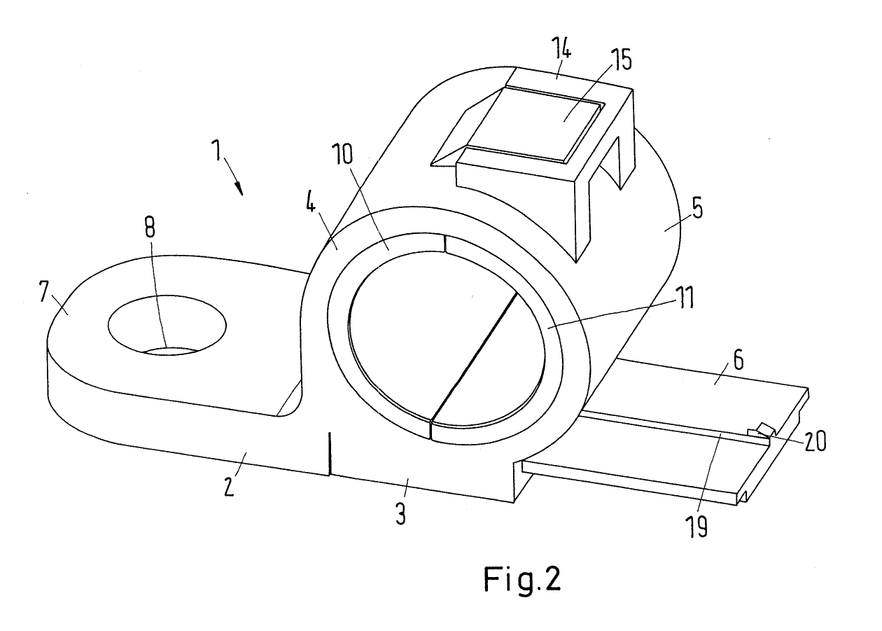

FIG. 2 now shows the clamp according to FIG. 1 in the closed state. The carriage 3 has been pushed against the base 2 so that the free ends 12, 13 of the arms 4, 5 have been placed against one another and the connection geometries 14, 15 are locked to one another. The arms 4, 5 then surround a circular closed cross section, in which a pipe or line element can be held, which has previously been inserted between the arms 4, 5 in the open state of the clamp 1.

An underside of the carriage 3 runs flush with the underside 9 of the base 2. The clamp 1 can thus be easily attached to smooth surfaces. At the same time, a force transfer from the carriage 3 to the smooth surface is possible so that overall a very stiff arrangement results.

A stop 20 can be provided at one end of the web 19, which stop serves to protect against loss. The carriage 3 then cannot easily be moved away from the base 2 beyond the stop 20. The maximum opening width of the clamp 1 is thus predetermined.

In particular, the use of thermoplastic material as a material for the base with the first arm and the guide as well as for the carriage with the second arm and the use of silicone for the insert results in a very light clamp with high stiffness, which renders possible an easy fixing of the pipe and/or line systems without additional cable ties or an additional tool. The clamp can be mounted first and the pipe or line element only subsequently inserted into the clamp. By a simple displacement of the second arm with the carriage with respect to the base, a simple closing of the clamp then takes place with an automatic locking of the connection geometries, wherein an independent opening of the clamp is ruled out.

The use of silicone prevents a transfer of vibrations from the pipe system or line system to the environment, whereby a secure retention of the pipe or line element is ensured. The clamp can also be used under extreme conditions, such as for example in the aircraft industry or automobile industry. The use of thermoplastic material and silicone permits the use of the clamp in a temperature range of −55° C. to +260° C. with simultaneous fuel resistance. The clamp has a high stiffness and a low weight. Depending on the requirement conditions, the clamp can also be produced from a different material, so that for example a cost-effective production of the clamp is possible.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A clamp for attaching pipes or lines, comprising:
a first arm arranged on a base; and
a second arm arranged on a carriage,
wherein the carriage is slidably arranged in the base so that the first and second arms are connectable to one another,

2. The clamp according to claim 1, wherein the first and second arms have free ends with a connection geometry.

3. The clamp according to claim 2, wherein the connection geometry produces a locking connection.

4. The clamp according to claim 1, wherein the base has an attachment section arranged on an end of the base facing away from the first arm.

5. The clamp according to claim 1, wherein the carriage comprises a guide that penetrates a recess of the carriage.

6. The clamp according to claim 1, wherein an underside of the carriage is structured to be flush with an underside of the base.

7. The clamp according to claim 1, wherein a guidable region of the carriage is accommodatable in part in a recess in the base.

8. The clamp according to claim 1, further comprising an insert comprising a first material arranged on an inside of the arms, wherein the base, the carriage and the arms comprise a second material.

9. The clamp according to claim 8, wherein the first material comprises a silicone.

10. The clamp according to claim 9, wherein the silicone comprises a liquid silicone.

11. The clamp according to claim 8, wherein the second material comprises a thermoplastic material.

12. The clamp according to claim 8, wherein the first and second materials of the clamp are fuel-resistant.

13. The clamp according to claim 1, wherein the clamp is structured for use in a temperature range of −55° C. to +260° C.

14. A clamp structured to connect pipes or lines, comprising:
a first arm connected to a base;
a second arm slidably guided in the base to slidably, whereby the first and second arms are slidably engageable with each other;
a locking element coupled to the first arm;
a complementary locking element coupled to the second arm; and
inserts formed on inside surfaces of the first and second arms.

15. The clamp according to claim 14, wherein the inserts comprise a first material and the base and the arms comprise a second material.

16. The clamp according to claim 15, wherein the first and second materials are fuel-resistant.

17. The clamp according to claim 15, wherein the first material comprises a silicone and the second material comprises a thermoplastic material.

18. The clamp according to claim 17, wherein the silicone comprises a liquid silicone.
